(19) United States
(12) Patent Application Publication
(10) Pub. No.: US 2008/0094524 A1
(43) Pub. Date: Apr. 24, 2008

(54) Audio Source Selection

(75) Inventor: Daniel Willem Elisabeth Schobben, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/573,367

(22) PCT Filed: Jul. 22, 2005
(86) PCT No.: PCT/IB05/52472

§ 371 Date: Feb. 7, 2007

(30) Foreign Application Priority Data
Aug. 12, 2004 (EP) 04103890.2

(51) Int. Cl. H04N 5/60

(52) U.S. Cl. 348/738; 348/E05.122

(57) ABSTRACT

A processor (4) receives (I1,I2) a first audio and/or video input signal (A1, V1), and a second audio and/or video input signal (Λ2, V2, Λ1b, Λ1c, Λ3, A5). A comparator (41) compares the fist audio or video input signal (A1, V1) and the second audio or video input signal (A2, V2; A1b, A1c, A3, A5), respectively, to detect a match between the first audio signal (A1) and the second audio signal (A2) or the first video signal (V1) and the second video signal (V2). A selector (42) supplies a selected signal ΛS) which is the second audio or video input signal (A2, V2) if the match is detected or the first audio or video input signal (A1, V1) otherwise.

### FIELD OF THE INVENTION

The invention relates to a processor, a receiver comprising the processor, a system comprising a display apparatus and the receiver, and a method of processing.

### BACKGROUND OF THE INVENTION

Usually, a home entertainment system comprises a display apparatus, a home cinema receiver, and a DVD player. The display apparatus may be a conventional cathode ray tube, a matrix display such as a LCD or a plasma display, or a beamer. The home cinema receiver comprises a source selector to select the input signals of a source which should be directed to the loudspeakers via multi-channel audio amplifiers. The multi-channel audio amplifiers may be part of the home cinema receiver. It is also possible that a radio tuner is incorporated into the home cinema receiver to receive radio audio signals. The DVD player may also be able to record DVDs and to handle CDs and SACDs. The home entertainment system may further comprise a VCR, a satellite recorder and other peripheral audio and/or video apparatuses.

In such a system, the user has to manually select the correct input source on the home cinema receiver. It thus can easily happen that the sound generated by the loudspeakers connected to the home cinema receiver does not or not optimally fit the image displayed on the display apparatus. For example, when the display apparatus displays DVD video to which both a stereo and a multi-channel audio signal is associated, the home cinema receiver may output the stereo signal instead of the multi-channel signal.

U.S. Pat. No. 6,678,014 discloses an apparatus for automatically selecting an audio signal of a digital television. If a digital audio signal is detected to be present, the digital audio signal is selected to be used in the digital television even if there is an analog audio signal present too. In this manner, the digital audio signal has a higher priority over the analog audio signal and thus the digital audio signal will be selected if it is present. However, this system only functions correctly if the analog and the digital signal originate from the same device. If the user makes a mistake in connecting the cables to the digital inputs, the audio signal which originates from another source will be selected.

### SUMMARY OF THE INVENTION

It is an object of the invention to provide an audio processor which correctly selects an input signal.

A first aspect of the invention provides a processor as claimed in claim 1. A second aspect of the invention provides a receiver as claimed in claim 13. A third aspect of the invention provides a system comprising the receiver as claimed in claim 15. A fourth aspect of the invention provides a method of processing audio signals as claimed in claim 17. Advantageous embodiments are defined in the dependent claims.

The processor in accordance with the first aspect of the invention may receive a first input signal and a second input signal. The first input signal may be an audio signal and/or a video signal, the second input signal may also be an audio signal and/or a video signal. A comparator compares the first input signal and the second input signal to detect a match between the first and the second input signal. A selector supplies a selected signal which is the second input signal if the match is detected, and which the first input signal otherwise. Thus, the second input signal is only selected-if it matches the first input signal. Consequently, it can not happen that the second input signal is selected although it is not related to first input signal.

Such a selection may be relevant if the second input signal has a higher quality than the first input signal. For example, a particular content source (for example, a DVD player) may provide both an analog stereo audio signal (the first signal) and an analog or digital multi-channel audio signal (the second signal). The processor now checks whether different audio signals correspond to each other (match each other), and, if so, selects the multi-channel audio signal. Alternatively, the processor may receive two correlated video signals (for example, component video signal via the standard Scart interface and a S-VHS or composite video signal) for which a match is found. It is even possible that when a match is found in the video signals, the audio signal selection is controlled.

In an embodiment as defined in claim 2, the processor receives a first input signal, a second input signal, and priority information indicating a priority between the first input signal and the second input signal. A comparator compares the first input signal and the second input signal to detect a match between the first and the second signal. A selector supplies a selected signal which is the second input signal if the match is detected and the priority of the second input signal is higher than that of the first input signal, the selected signal is the first input signal otherwise.

In the description of the now following, the claimed processor which may process audio and/or video signals is elucidated, by way of example, with respect to matching of audio signals. The first input signal is now referred to as the first audio input signal (which is also referred to as the first audio signal) and the second input signal is now referred to as the second audio input signal (which is also referred to as the second audio signal). This does not exclude that the matching may also be done on the video signals associated with these audio signals as is intended by the wording of the claims.

Thus, if a (peripheral) audio/video apparatus supplies the first audio input signal, the receiver, which usually is a home cinema receiver, will output either this first audio signal or a second audio signal. The second audio signal may originate from the same audio/video apparatus and is then correlated with the first audio signal, or does not originate from the same audio/video apparatus but may or may not be correlated with the first audio signal. If the second audio signal does not match the first audio signal, the first output signal is outputted. If the second audio signal matches the first audio signal, and thus is related to the same information, the second audio signal is outputted if it is known that the second audio signal has a higher priority than the first audio signal. Otherwise, the first signal will be outputted even if there is a match. This approach is especially useful in a home cinema receiver to which a plurality of audio/video devices is connected.

For example, the first and the second audio input signal originate from the same audio/video apparatus, and it is stored that inputs which receive a digital input audio signal have a higher priority than inputs which receive an analog audio signal. If the audio processor of the receiver finds a match between the first and the second audio input signal, the digital audio signal is selected; otherwise the analog audio signal is selected. In this example, the match will be found if all cables are properly connected. However, if the cable transporting the digital signal is incorrectly connected, for example because the user connected a cable carrying a signal of another content source, a digital signal is supplied which is not related to the analog signal. No match will be found and the incorrect digital signal will not be selected. Alternatively, it may be known that inputs which receive a multi-channel audio signal have a higher priority than inputs which receive a stereo signal. The match may also be determined between more than two audio signals. In this example, both the digital stereo audio signal and the digital multi-channel audio signal may be tested for a match with the analog audio signal. With a multi-channel audio signal is meant an analog or digital audio signal which has more than two audio channels.

In another example, the first and second audio input signals originate from different audio/video apparatus, or said more general: from different content sources. The content source may, for example, be a storage media, internet, or WLAN or other wireless device. Now, it is not on beforehand clear whether a match exists. It therefore has to be checked whether a match is present and if so what the priority of the matching audio signal is. Preferably, all the audio input signals are checked on a match. For the matching input audio signal(s) is determined which one has the highest priority. The audio input signal which matches the first audio input signal and which has the highest priority is selected.

This, for example, can be advantageously used in a home entertainment system in which the audio signal belonging to the image displayed is supplied by the display apparatus to the home cinema receiver which comprises the audio processor. For example, for display apparatuses which comprise a scart connector, a scart cable between the display apparatus and the home cinema receiver transports the stereo audio signal belonging to the image displayed on the display apparatus from the display apparatus to the home cinema receiver. Now, when the home cinema receiver is instructed to be in the display apparatus mode, the home cinema receiver knows which audio signal belongs to the image displayed. In the display apparatus mode, the selector of the home cinema receiver is controlled such that at least the audio signal of the display apparatus is available to the home cinema receiver. The home cinema receiver checks all other audio inputs on the presence of an audio signal which is related to the first audio signal supplied by the display apparatus. If a match is found and if the priority of this later, second, audio signal is higher, the later audio signal will be selected to be sent to the speakers, otherwise, the audio signal supplied by the display apparatus will be sent to the speakers.

For example, if the image displayed on the display apparatus originates from a DVD player which is connected via a scart-cable to the display apparatus, the display apparatus will output the analog stereo audio signal received via the scart-cable from the DVD player via another scart cable connected to the home cinema receiver as the first audio signal. Further, the DVD player is connected via a cable to the home cinema receiver to supply the digital multi-channel audio signal as the second audio signal to a suitable input of the home cinema receiver. The audio processor finds a match between the first and the second audio signal, knows that the second audio signal has the highest priority and thus automatically selects the digital multi-channel audio signal which is decoded and made audible.

Alternatively, the matching approach in accordance with the invention can be advantageously used in an audio-video system which is connected to a content source, for example by phone, internet, or any other wired or wireless connection. The first audio signal is compared with a second audio signal retrieved from the content source; if it matches and has the higher priority it is selected. For, example, in a home entertainment system, an analog stereo signal or a relevant parameter(s) thereof is intermittently or continuously provided to the content provider. The relevant parameter may be a fingerprint of the audio signal. If a better audio signal is present, the content provider provides this better signal. The audio processor continuously checks the input of the home cinema receiver which receives the content provided by the content provider and uses this audio signal if it matches and has a higher priority. A better signal, for example, may be an audio signal with a higher signal to noise ratio, a digital audio signal instead of an analog audio signal, or a multi-channel audio signal instead of a stereo audio signal.

From Philips audio-visual apparatuses on the market, a so called cinema-link is known. The cinema-link is a communication bus between the home cinema receiver, the display apparatus, and other peripheral apparatuses. The home cinema receiver is instructed via this communication bus to automatically select the sound signal of a peripheral apparatus when it becomes active. The user does not need to manually instruct the home cinema receiver to select the correct inputs. It is a drawback of the cinema-link that all apparatuses involved should be provided with circuitry required for operating the cinema-link. Usually, other brands than Philips do not have a cinema-link. If one of the apparatuses does not have the cinema-link functionality, the user must manually select the source.

U.S. Pat. No. 6,052,471 discloses a receiver with a control circuitry which automatically detects which signals from a plurality of audio and/or visual source devices are present. The control circuit comprises priority logic which determines which one of the present signals has the highest priority. A selector selects the present signal with the highest priority for use. Thus, if the user starts a source device that serves as a potential source of audio and/or visual input signals to the receiver, the receiver control circuitry automatically determines whether the receiver should switch to this source device as its source of audio and/or visual information, so that this will not have to be done by the user of the receiver. This prior art does not have the benefits obtained by only selecting an audio signal if it matches another audio signal and has a higher priority. A further drawback is illustrated with the now following example. It is assumed that the starting situation is that a TV is active and that the receiver has selected the TV signals. If now a DVD player becomes active, the receiver detects its signal and switches over to its DVD input(s). If the user likes to switch over to TV while the DVD is still playing, this prior art still selects the DVD. In an embodiment with the invention, the output signal of the TV is leading and thus when this output signal changes from DVD to TV-tuner, the receiver will know this and start searching for a matching input signal. If the match is found this signal is selected, otherwise the tuner signal received from the TV will be selected.

U.S. Pat. No. 6,678,014, which is already referred to earlier, fails to check whether the digital signal is related to the analog signal and whether other signals may be inputted which match the analog signal. Thus even if the digital signal does not match the analog signal at all it will be selected. Further, more than one audio signal may be present which matches the analog audio signal and should prevail over the digital signal audio signal. For example, an analog or digital multi-channel signal might have to prevail over a digital stereo signal.

In an embodiment as defined in claim 4, a well known cross-correlation technique is used to detect whether the first and the second audio signals match. It might be required to pre-process one or both of the first and the second audio signals to optimize their resemblance. For example, an analog audio signal may first be digitized before it is compared with a digital audio signal, or the other way around.

In an embodiment as defined in claim 5, a well known finger-print technique is used to detect whether the first and the second audio signals match. Again, first a pre-processing may be applied before the audio signals are compared. The finger prints need not match one to one, a sufficiently high correlation suffices.

In an embodiment as defined in claim 6, the first and the second audio signal originate from the same source, for example a DVD player. For example, as defined in claim 7, the first signal is an analog stereo audio signal and the second signal is a digital multi-channel signal. The audio processor will select the higher priority multi-channel signal, but only if it matches the analog stereo audio signal. To determine the match, a pre-processing may be required. For example, as defined in claim 8, a decoder may decode the multi-channel audio signal into a stereo audio signal, or as defined in claim 10, the analog stereo audio signal is digitized before the comparison is made.

In an embodiment as defined in claim 13, a receiver comprises the audio processor. The receiver has inputs to receive the first audio signal A1 and the second audio signal A2, and has an output to supply the selected audio signal. For example, the receiver may be a multi-channel selector/pre-amplifier home cinema receiver or amplifier, or a full multi-channel home cinema receiver or amplifier. The home cinema receiver or amplifier is further also referred to as the AV-receiver or AV-amplifier or just receiver or amplifier. The difference between an AV-amplifier and an AV-receiver is that the later comprises a radio tuner. The difference between the selector/pre-amplifier receiver or amplifier and the full receiver or amplifier is that the latter includes the audio output amplifiers required to drive the loudspeakers. The receiver may also comprise other functionality, such as a CD/DVD(/DVD-A, SACD) player/recorder, or an interface for communication with a content provider, such as an internet connection or an I-link.

In an embodiment as defined in claim 14 the receiver comprises such an interface for communication with a content provider. The audio signal supplied via this interface is selected if it matches the first audio signal and has the highest priority.

In an embodiment as defined in claim 15, the receiver is part of a system which comprises a display apparatus and an audio-video source. The audio-video source supplies the first audio signal and a video signal to the display apparatus. This video signal is actually displayed on the display apparatus. The display apparatus forwards the first audio signal to the receiver which is physically separated from the display apparatus. The receiver further receives the second audio signal. The audio processor of the receiver compares the first and the second audio signals and selects the second audio signal if it matches and has the highest priority. Otherwise, the first audio signal is selected.

In an embodiment as defined in claim 16, the first and the second audio signals originate from the same audio-video source. For example, the first audio signal is an analog stereo signal and the second audio signal is a digital multi-channel signal.

These and other aspects of the invention are apparent from and will be elucidated with reference to the embodiments described hereinafter.

### BRIEF DESCRIPTION OF THE DRAWINGS

In the drawings:

FIG. 1 shows a block diagram of a system which comprises a display apparatus, an audio-video source and an audio processor,

FIG. 2 shows a more detailed block diagram of a system which comprises an audio-video source, an audio source, a display apparatus, and a receiver which comprises the audio processor,

FIG. 3 shows a detailed block diagram of an embodiment of the audio processor, and

FIG. 4 shows a detailed block diagram of another embodiment of the audio processor.

### DETAILED DESCRIPTION OF THE PREFERRED EMBODIMENT

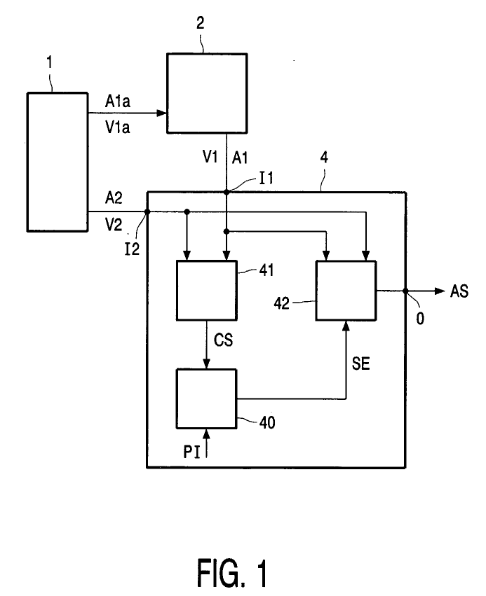

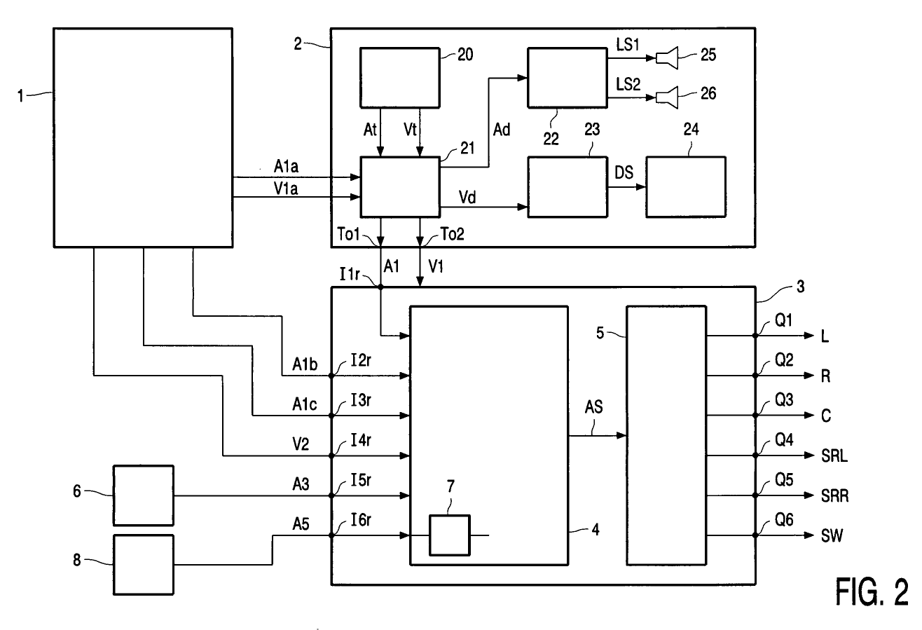

FIG. 1 shows a block diagram of a system which comprises a display apparatus, an audio-video source (further referred to as AV-source) and an audio processor. The AV-source 1 supplies a first audio signal Ala which is accompanied by a video signal V1a to the display apparatus 2. The display apparatus 2 comprises a selector (not shown in FIG. 1, see FIG. 2) to select which signal should be displayed on its display. The selector is in a position to display the video signal V1a and to supply the audio signal A1a as the audio signal A1 and/or the video signal V1 to the input I1 of the audio processor 4. The audio signal A1 and the video signal V1 resemble the audio signal A1a and the video signal V1a, respectively, very much. These signals only have to pass the selector and may be amplified/buffered. Also, some pre-processing as noise suppression may be performed on the audio signal A1a and the video signal V1a. The audio signal Al and the video signal V1 belong to the same information and thus are related. For example, the AV-source 1 comprises a DVD player which supplies an analog stereo signal as the audio signal A1 and component video as the video signal V1. The display apparatus 2 may be a television apparatus, a computer monitor, a beamer, or any other display apparatus suitable to display images to which audio is associated. The first audio signal A1a is transported over an interface cable to the display apparatus 2. This interface cable may be a standard scart cable which also transports the video signal V1a from the AV-source 1 to the display apparatus 2.

The audio processor 4 comprises a further input I2 to receive a second audio signal A2 and/or a second video signal V2 which also originate(s) from the AV-source 1. For example, the second audio signal A2 is a digital stereo or multi-channel audio signal. The audio signal A2 may alternatively be an analog or digital multi-channel audio signal. The audio signal A2 may be transported by a single digital interface cable or by a plurality of analog interface cables. The video signal V2 may be composite video.

The audio processor 4 comprises a comparator 41, a controller 40 and a selector 42. The comparator 41 receives the (first) audio signal A1 and the (second) audio signal A2 and supplies a comparison signal CS. The comparison signal CS indicates whether the comparator 41 detects a match between the first audio signal A1 and the second audio signal A2. The comparator 41 may use well known cross-correlation or fingerprinting techniques to determine whether the match exists. An example of a suitable cross-correlation technique is disclosed in “Theory and application of Digital Signal Processing”, L. R. Rabiner and B. Gold, Prentice Hall, 1975. An example of a suitable fingerprinting technique is disclosed in U.S. Pat. No. 6,453,252. The fingerprint of an audio signal is generated based on the energy content in frequency sub-bands. Processing techniques assure a robust identification fingerprint useful to identify signals which are altered after the fingerprint was generated. The fingerprint is compared to a database to identify the audio signal. A match is not intended to mean that the signals compared should be identical, or that the cross-correlation should be 100%, or that the fingerprints should be identical. It may suffice if the signals or the fingerprints are almost identical, or that the cross-correlation is higher than a predetermined level.

The controller 40 receives the comparison signal CS and optionally the priority information PI to supply the select signal SE. The priority information PI indicates the priority of different audio signals. For example, the priority information PI may indicate that a multi-channel audio signal has a higher priority than a stereo signal, and that a digital audio signal has a higher priority than an analog audio signal. The priority information PI may be stored in a memory, or may be determined based on the origin of the signal and thus may be dependent on the input on which the signal is present. Alternatively, a signal with a higher signal to noise ratio may have a higher priority than a signal with a lower signal to noise ratio.

The selector 42 receives the first audio input signal A1, the second audio input signal A2, and the select signal SE to supply a selected audio signal AS to an output O. If the comparison signal CS indicates that the second audio signal A2 matches the first audio signal A1, and the priority information PI indicates that the priority of the second audio signal A2 is higher than that of the first audio signal A1, the select signal SE controls the selector 42 to select the second audio signal A2 as the selected audio signal AS. In all other situations, the select signal SE controls the selector 42 to select the first audio signal A1 as the selected audio signal AS.

By way of example, the AV-source 1 is a DVD player, the first audio signal Al is an analog stereo audio signal, and the second audio signal A2 is a digital multi-channel audio signal. The priority of the digital multi-channel audio signal prevails above the priority of the analog stereo audio signal. Because both the first audio signal A1 and the second audio signal A2 originate from the same AV-source 1, they are correlated and thus the comparator 41 will detect a match. Because both a match is detected and the priority of the second audio signal A2 is the highest, the second audio signal A2 will be automatically selected. If no priority information is used, the second audio signal A2 is selected if it matches the first audio signal A1. Thus, the user does not have to take any action. As long as the audio processor 4 receives the first audio signal A1, it is able to detect whether the second audio signal A2 is matching, and knowing the priorities, the highest priority audio signal will be selected. Thus, if the second (multi-channel) audio signal A2 matches the first (stereo) audio signal A1, this better second audio signal A2 will be selected and thus be heard. If the second audio signal A2 does not match the first audio signal A1, this first audio signal A1 is selected. No match is detected, for example, if the user did not attach a cable between the AV-source 1 and the input I2 of the audio processor 4, or if the user attached a cable to the input I2 which provides a sound signal from a source different than the AV-source 1.

In the same manner, instead of comparing audio signals, also the video signals V1 and V2 may be compared to control the selection.

FIG. 2 shows a more detailed block diagram of a system which comprises an AV-source, an audio source, a display apparatus, and a receiver which comprises the audio processor. The system now comprises an AV-source 1, an audio source 6, a data source 8, a display apparatus 2 and an audio-video receiver 3 (further referred to as AV-receiver or receiver).

The AV-source 1 may be a DVD player which supplies an analog stereo audio signal A1a and a component video signal V1a to the display apparatus 2. The AV-source supplies an analog multi-channel audio signal A1b, and a digital stereo or multi-channel audio signal A1c and optionally a composite (or S) video signal V2 to inputs I2r, I3r and I4r of the receiver 3, respectively. Usually, either the digital multi-channel audio signal or the digital stereo signal is present on the same interface cable connected between the DVD player 1 and the receiver 3. The video signal V1a may be component video signal (R, G, B, not shown) and the video signal V2 may be a composite video signal. Instead of the DVD player 1 any other AV-source which supplies different sound formats and/or video formats in parallel can be used. The audio source 6 supplies a multi-channel analog or digital signal A3 to the input I5 of the receiver 3. The remote content source 8 supplies information A5 to the input I6 of the receiver 3. This information A5 may be a digital data stream. The remote content source 8 may be, for example, an internet server.

The display apparatus 2, which in this embodiment is a TV comprises a tuner 20, a selector 21, a sound processor 22, a video processor 23, two loudspeakers 25 and 26, and a display 24. The tuner 20 receives television programs and supplies the television audio signal At and the television video signal Vt. The selector 21 selects the television audio signal At and the television video signal Vt from the tuner 20, or the analog stereo audio signal A1a and the video signal V1a from the AV-source 1. The selected audio signal Ad is supplied to the sound processor 22 which supplies loudspeaker signals LS1 and LS2 to the loudspeakers 25 and 26. The selected video signal Vd is supplied to the video processor 23 which supplies drive signals DS to the display 24. The selected audio and video signals are also supplied to the outputs TO1 and TO2 of the display apparatus 2 as the output audio signal A1 and the output video signal V1, respectively. In FIG. 2, the selector 21 selects the analog stereo audio signal A1a and the video signal V1a from the AV-source 1. The output video signal V1 is related or identical to the video signal V1a, the output audio signal A1 is related or identical to the audio signal A1a. With related to is meant that the signals mentioned are processed but such that they have a very high resemblance, for example, only the amplitudes are different, or a noise reduction algorithm is performed. The output video signal V1 and the output audio signal A1 are supplied to the input I1r of the receiver 3 via a standard interface cable, for example, via a scart cable.

The receiver 3 comprises the audio processor 4 and a decoder/output amplifier 5. The audio processor 4 receives the analog stereo output audio signal A1 via the input I1r, the analog multi-channel audio signal A1b via the inputs I2r, the digital stereo or multi-channel audio signal A1c via the input I3r, the multi-channel analog or digital signal A3 via the input I5r, and the audio signal A5 which originates from a distant content source 8 via the input I6r. The distant content source 8 may be coupled via wire or wireless (for example, WLAN), for example, by phone or by internet.

The audio processor 4 comprises the comparator 41, the controller 40 and the selector 42 shown in FIG. 1 (not shown in FIG. 2). The comparator 41 checks each (or a relevant sub-group) of input audio signals A1b, A1c, A3, A5 whether there is a match. If at least one match is found, the priority of the matching input audio signal(s) is checked and the matching input audio signal with the highest priority is selected to be supplied to the decoder/output amplifiers 5. The selected audio signal AS may be a digital signal which is first decoded 5 before it is amplified by output amplifiers 5. The selected audio signal AS may be an analog audio signal which only needs to be amplified by the amplifiers 5. It is also possible that all digital audio signals are first decoded into analog audio signals before the selection is made. Now the decoder/amplifiers 5 only comprise amplifiers. FIG. 2 shows, by way of example only, a 5.1 channel AV-receiver 3 which has 6 outputs Q1 to Q6, respectively, to supply output signals to the following speakers: a front left speaker L, a front right speaker R, a center speaker C, a left surround speaker SRL, a right surround speaker SRR, and a sub-woofer SW. In the system shown in FIG. 2, the digital multi-channel audio signal A1c has the highest priority, and when present will match the analog stereo audio signal A1a (and thus A1) and thus will be selected. If not present, for example because the DVD is stereo only, or if the cable transporting the digital audio signal A1c is not present, the audio signal A5 may be a better signal. The audio signal A5 may only be present if the content provider first received information characterizing the audio output signal A1. This information may be sent always or only if no better audio signal is found. If the content provider has a better matching audio signal this is provided from the distant content source 8 of the content provider to the input I6r. The input I6r need not be an actual plug, it may, for example also be an infrared or other wireless receiver. The processor 4 may comprise a communication unit 7 being able to process the data which is received over the input I6r.

The receiver 3 may comprise a radio tuner (not shown), the output amplifiers need not be able to directly drive loudspeakers. A separate amplifier may be used to drive the loudspeakers.

Instead of comparing audio signals to find a match, also video signals may be compared. For example, the processor 4 (up till now referred to as audio processor) may also compare the video signal V2 with the video signal V1. If a match is found, the video signal which has the highest priority is selected and/or the associated one of the audio signals A1b, A1c may be selected. Or if several matches are found, for example if the content source 8 is also supplying a matching video signal the signal which has the highest priority is selected.

A further option may be that the receiver 3, if in stand-by, is activated when a signal is detected on one or particular ones of its inputs I1r to I6r. Further, the receiver 3 may switch to an input of which is detected that a signal becomes available. For example, the starting situation is that the audio source 6 is a CD player 6 which is active and the receiver 3 has selected the CD-player signal A3 to be outputted as the selected signal AS. Now the television receiver 2 is switched on, and the AV-receiver 3 detects that the signal A1 on the scart input I1r coupled via a scart cable to the TV receiver 3 becomes active. Now the AV- receiver 3 automatically switches over to this scart input I1r and starts searching for a matching signal present on another input I2r to I6r. The AV-receiver 3 stores the input which was active before the switch over. When the TV receiver 2 is switched off, the AV-receiver 3 selects the input of which is stored that it was active before the switch over.

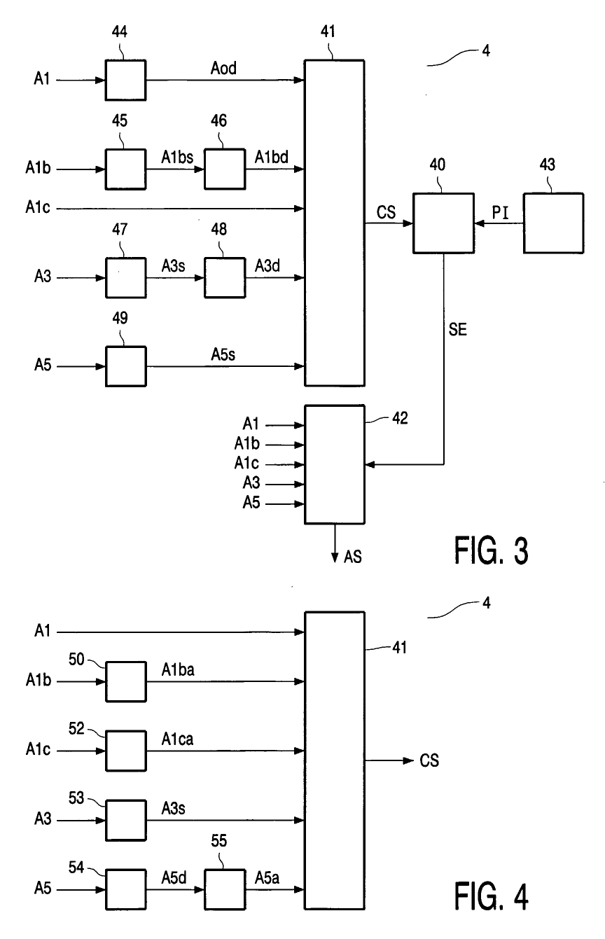

FIG. 3 shows a detailed block diagram of an embodiment of the audio processor 4. All signals which have the same references as in FIG. 2 are identical to the signals of FIG. 2. The audio processor 4 comprises a comparator 41 which operates in the digital domain. The analog to digital converter 44 converts the analog stereo audio signal Al into a digital audio signal Aod. The multi-channel to stereo converter 45 converts the multi-channel analog audio signal A1b into an analog stereo audio signal A1bs. The analog to digital converter 46 converts the analog stereo audio signal A1bs into a digital stereo signal A1bd. The stereo or multi-channel digital audio signal A1e is fed directly to the comparator 41. If the audio signal A1c is a multi-channel signal it may be digitally processed in the comparator 41 to first obtain a digital stereo signal before the matching is checked. The multi-channel to stereo converter 47 converts the multi-channel analog audio signal A3 into an analog stereo audio signal A3s. The analog to digital converter 48 converts the analog stereo audio signal A3s into a digital stereo signal A3d. The protocol decoder 49 receives coded digital information A5 (for example, coded with the internet protocol, or with wireless protocols) and retrieves the stereo information A5s. The analog to digital converters 44, 46 and 48 may be separate circuits, or may be used in time multiplex.

Thus, now, all audio signals which are matched are digital stereo signals, and the quality of the matching is improved. The digital comparator 41 supplies the comparison signal to the controller 40. The controller 40 further may receive the priority information PI which is stored in the memory 43, and supplies the select signal SE to the selector 42. The selector 42 receives the input audio signals A1, A1b, A1c, A3 and A5 and supplies the selected audio signal AS which is one of the input audio signals A1, A1b, A1c, A3 and A5. Actually, the selector 42 may comprise an analog part for selecting the analog input audio signals, and a digital part for selecting the digital audio signals. Alternatively, the analog signals may be digitized and the selector 42 is a digital circuit.

FIG. 4 shows a detailed block diagram of another embodiment of the audio processor. All signals which have the same references as in FIG. 3 are identical to the signals of FIG. 3.

The audio processor 4 comprises a comparator 41 which now operates in the analog domain. The analog stereo audio signal A1 is directly fed to the comparator 41. The multi-channel to stereo converter 50 converts the analog multi-channel audio signal A1b into an analog stereo audio signal A1ba. The digital to analog converter 52 converts the stereo or multi-channel digital audio signal A1c into a stereo analog audio signal A1ca. If the audio signal A1c is a multi-channel signal it may be digitally processed in the digital to analog converter 52 to first obtain a digital stereo signal before it is converted into an analog stereo signal. The multi-channel to stereo converter 53 converts the multi-channel analog audio signal A3 into an analog stereo audio signal A3s. The protocol decoder 54 receives coded digital information A5 (again, for example, coded with the internet protocol, or with wireless protocols) and retrieves the digital stereo information A5d. The digital to analog converter 55 converts the digital stereo information A5d into the analog stereo audio A5a. The digital to analog converters 52 and 55 may be separate circuits, or may be used in time multiplex.

Thus, now, all audio signals which have to be matched are analog stereo signals, and the quality of the matching is improved. The analog comparator 41 supplies the comparison signal CS. The selector 42 (not shown, see FIG. 3) receives the input audio signals A1, A1b, A1c, A3 and A5 and supplies the selected audio signal AS which is one of the input audio signals A1, A1b, A1c, A3 and A5. Actually, the selector 42 may comprise an analog part for selecting the analog input audio signals, and a digital part for selecting the digital audio signals. Alternatively, the digital audio signals may be converted into analog audio signals and the selector 42 is an analog switching circuit.

In a preferred embodiment, the processor 4 receives a first audio and/or video signal A1, V1, and a second audio and/or video signal A2, V2; A1b, A1c, A3, A5. The comparator 41 compares the first audio or video signal A1; V1 and the second audio or video signal A2, A1b, A1c, A3, A5; V2, respectively, to detect a match between the first audio signal A1 and the second audio signal A2 or the first video signal V1 and the second video signal V2. A selector 42 supplies a selected signal AS which is the second audio or video signal A2, V2 if the match is detected or the first audio or video signal A1, V1 otherwise.

It should be noted that the above-mentioned embodiments illustrate rather than limit the invention, and that those skilled in the art will be able to design many alternative embodiments without departing from the scope of the appended claims.

Although the majority of embodiments and examples are directed to comparing audio signals to determine a match, video signals may be compared as well, although this involves a higher processing effort. The matching of signals need not be done with exactly the same signals. For example, a high correlation (directly or of the fingerprints) might be detected for one of the channels of a stereo audio signal and one of the channels of the multi-channel audio signal. For example if the DVD player supplies the center channel audio signal to TV-receiver, such that the loudspeakers of the TV-receiver are used as the center speaker, this center audio signal is used for finding a match. A reliable match may still be possible between this center audio signal and one or more channels of another audio signal, especially if the robust fingerprinting technique is used. Or, one of the components of component video may be compared with the luminance information of a S-VHS video signal.

Although with respect to FIGS. 3 and 4 is elucidated that the input signals can be received in parallel by the comparator 41, alternatively, the input signals may be selected one by one and the required pre-processing functions need to be present only once. Dependent on the nature of the input signal the correct pre-processing is selected or performed.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A processor (4) for receiving (I1) a first input signal (A1, V1) comprising a first audio signal (A1) and/or a first video signal (V1) and for receiving (I2) a second input signal (A2, V2; A1b, A1c, A3, A5) comprising a second audio signal (A2; A1b, A1c, A3, A5) and/or a second video signal (V2), the processor comprising:
a comparator (41) for comparing the first input signal (A1, V1) and the second input signal (A2, V2; A1b, A1c, A3, A5) to detect a match between the first input signal (A1, V1) and the second input signal (A2, V2; A1b, A1c, A3, A5), and a selector (42) for supplying a selected signal (AS) being the second input signal (A2, V2; A1b, A1c, A3, A5) if the match is detected or being the first input signal (A1, V1) if no match is detected.

2. A processor (4) as claimed in claim 1, further comprising means (40) for receiving priority information (PI) indicating a priority between the first input signal (A1, V1) and the second input signal (A2, V2; A1b, A1c, A3, A5), and wherein the selector (42) is arranged for supplying the selected signal (AS) being the second input signal (A2, V2; A1b, A1c, A3, A5) if the match is detected and the priority indicates that the second input signal (A2, V2; Alb, A1c, A3, A5) is preferred above the first input signal (A1, V1), or for supplying the first input signal (A1, V1) otherwise.

3. A processor (4) as claimed in claim 1, comprising a first input (I1) for receiving the first input signal (A1, V1) from an external source (1) and a second input (I2) for receiving the second input signal (A2, V2; A1b, A1c, A3, A5) from said external source (1) or from a further external source, and wherein the processor (4) further comprises an output (O) for supplying the selected signal (AS).

4. A processor (4) as claimed in claim 1, wherein the comparator (41) comprises a cross-correlation determining circuit (41) for determining a cross-correlation between the first input signal (A1, V1) and the second input signal (A2, V2; A1b, A1c, A3, A5), the match being detected if the cross-correlation is higher than a predetermined value.

5. A processor (4) as claimed in claim 1, wherein the comparator (41) comprises a finger-print determining circuit (41) for determining a first fingerprint of the first input signal (A1, V1) and a second fingerprint of the second input signal (A2, V2; A1b, A1c, A3, A5), the match being detected if the first and the second fingerprint match.

6. A processor (4) as claimed in claim 1, wherein the first input signal (A1, V1) and second input signal (A2, V2; A1b, A1c, A3, A5) originate from a same source (1).

7. A processor (4) as claimed in claim 1, wherein the first input signal (A1, V1) is the first audio signal (A1) being a stereo audio signal, and wherein the second input signal (A2, V2; A1b, A1c, A3, A5) is the second audio signal (A2; A1b, A1c, A3, A5) being a multi-channel audio signal.

8. A processor (4) as claimed in claim 7, further comprising a decoder (45, 46, 50, 53) for converting the multi-channel audio signal into a further stereo signal, and wherein the comparator (41) is arranged for comparing the stereo audio signal and the further stereo signal.

9. A processor (4) as claimed in claim 1, wherein the first input signal (Al, V1) is the first audio signal (A1) being an analog audio signal, and wherein the second input signal (A2, V2; A1b, A1c, A3, A5) is the second audio signal (A2; A1c, A5) being a digital audio signal.

10. A processor (4) as claimed in claim 9, further comprising an analog to digital converter (44, 47) for converting the analog audio signal into a further digital audio signal, and wherein the comparator (41) is arranged for comparing the further digital audio signal with the digital audio signal.

11. A processor (4) as claimed in claim 1, wherein the first input signal (A1, V1) is the first audio signal (A1), and wherein the second input signal (A2, V2; A1b, A1c, A3, A5) is the second audio signal (A2; A1b, A1c, A3, A5).

12. A processor (4) as claimed in claim 1, wherein the first input signal (A1, V1) is the first video signal (V1), and wherein the second input signal (A2, V2; A1b, A1c, A3, A5) is the second video signal (V2).

13. A receiver (3) comprising the processor (4) as claimed in claim 1, the receiver (3) having a first receiver input (I1r) for receiving the first input signal (A1, V1), a second receiver input (I2r) for receiving the second input signal (A2, V2; A1b, A1c, A3, A5), and a receiver output (Q1, Q2, Q3, Q4, Q5, Q6) for supplying an output audio signal (L, R, C, SRL, SRR, SW) being related to the selected signal (AS).

14. A receiver (3) as claimed in claim 13, wherein the processor (4) further comprises a wireless or wired communication unit (7) for communicating with an external information source (8) to receive the second input signal (A5).

15. A system comprising:
an audio-video source (1) for supplying a first audio output signal (A1a) and a first input video signal (V1a);
a display apparatus (2) having a video input for receiving the first input video signal (V1a) to supply the first video signal (V1) being related to first input video signal (V1a), and/or an audio input for receiving the first audio input signal (A1a) to supply the first audio signal (A1) being related to the first audio input signal (A1a), an image processor (23) for processing the first video signal (V1) to obtain a display signal (DS), a display (24) for displaying the display signal (DS); and
a receiver (2) as claimed in claim 13 being physically separated from the display apparatus (2).

16. A system as claimed in claim 15, wherein the audio-video source (1) is arranged for also supplying the second audio signal (A2) being different than, but related to, the first audio signal (A1).

17. A method of processing comprising receiving (I1, I2) a first input signal (A1, V1) comprising a first audio signal (A1) and/or a first video signal (V1) and a second input signal (A2, V2; A1b, A1c, A3, A5) comprising a second audio signal (A2; A1b, A1c, A3, A5) and/or a second video signal (V2), comparing (41) the first input signal (A1, V1) and the second input signal (A2) to detect a match between the first input signal (A1, V1) and the second input signal (A2), and supplying (42) a selected signal (AS) being the second input signal (A2) if the match is detected or being the first input signal (A1, V1) if no match is detected.
